(19) United States
(12) Patent Application Publication
(10) Pub. No.: US 2004/0222975 A1
(43) Pub. Date: Nov. 11, 2004

(54) Personal digital assistant and program used therefor

(75) Inventors: Masao Nakano, Kanagawa-ken (JP); Masao Nakazawa, Yokohama-shi (JP); Yoshio Sasaki, Kanagawa-ken (JP); Eiji Takeuchi, Yokohama-shi (JP); Yosuke Miho, Yokohama-shi (JP); Hajime Ishikawa, Yokohama-shi (JP); Takeo Kobayashi, Yokohama-shi (JP); Tomoki Myoi, Kawasaki-shi (JP); Hiroshi Kasakawa, Yokohama-shi (JP); Akiko Watanabe, Tokyo (JP); Shinsuke Sato, Fujisawa-shi (JP)

Correspondence Address: SCHULTE ROTH & ZABEL LLP, ATTN: JOEL E. LUTZKER, 919 THIRD AVENUE, NEW YORK, NY, 10022, US

(73) Assignee: Kyocera Corporation, Kyoto-shi (JP)

(21) Appl. No.: 10/791,161

(22) Filed: Mar. 1, 2004

(30) Foreign Application Priority Data
Feb. 28, 2003 (JP) 2003-54804

(51) Int. Cl. G09G 5/00

(52) U.S. Cl. 345/173

(57) ABSTRACT

The object of the present invention is to provide an digital personal assistant with easy operationality when transitioning operation pages. A variety of operation pages can be displayed selectively on a liquid crystal display panel 12 having a touch panel 12a. A control switch 13 is supported to be able to be rotated in a predetermined angle range and pushed-in at the reference position of said rotation. An operation signal is sent out in response to the turn or push in operation of the control switch. A CPU 21 judges whether the touch panel is touched or the control switch is operated. When it is judged that the touch panel is touched, the CPU allows the first page transition to be done whereby the operation page displayed on the liquid crystal display panel is transitioned in accordance with the touch operation. When it is judged that the control switch is operated, the CPU allows the second page transition to be done whereby the operation page displayed on the liquid crystal display panel is transitioned in accordance with the signal from the control switch.

### CROSS-REFERENCE TO RELATED APPLICATIONS

This application claims all rights of priority to Japanese Patent Applications Serial No. P2003-054804, filed Feb. 28, 2003 (pending).

### BACKGROUND OF THE INVENTION

1. Field of the Invention

The present invention relates to a personal digital assistant, particularly to a personal digital assistant improved in operationality and a program to be used for the digital assistant.

2. Description of the Related Art

In general, among information processing equipment, an information terminal which performs data processing in compliance with the input position (item) on the touch panel of the terminal touched by a touch pen is known. There is also disclosed an information terminal provided with switches in addition to the touch panel to select the page to be displayed in compliance with the operation of the switches, the switches being able to be operated independently of the touch pen.

For example, in the information input equipment disclosed in Japanese Laid-Open Patent Application No.6-195175 (hereafter referred to as example 1 of prior art), data processing is performed in compliance with the input position (item) on the touch panel detected on the touch panel, and a switch is provided independently of the touch panel in order to select a page to be displayed on the screen in compliance with the operation of the switch. With the equipment, the condition when the switch is pushed down is defined as main condition and that when the switch is released is defined as secondary condition, and in the secondary condition a secondary picture is displayed on the screen resulting in improved operationality.

In recent years, a personal digital assistant (hereafter referred to as PDA) smaller than a note book type personal computer (PC) is available in the market. PDAs are constructed small and thin such that they can be hold on the palm of the hand and are used outdoors as portable terminals, that is, they are used in so-called mobile environment. A PDA accommodates a variety of information to assist a person in carrying out daily operations and can exchange data with others by connecting with communication equipment (for example, a portable telephone).

With a PDA like this, as it is very small sized as mentioned above, input is done by so-called pen-touching, that is, upon touching a desired item of the picture on the display the page is transferred to a picture corresponding to that of the item touched by the touch pen. With the portable information processing equipment with pen-touch input device disclosed in Japanese Laid-Open Patent Application No.6-301648 (hereafter referred to as example 2 of prior art), function switches are provided on the equipment, and the data to be outputted from the data setting part is selected according to the conditions of on-off of the switches. Therefore, the changeover of function is done by the function switches and then input is done by pen-touching.

Further, there is portable information processing equipment which is provided with a so-called jog dial. With the portable information processing equipment with a jog dial, turning and pushing down operation, etc. of the jog dial is detected and data processing is performed according to the operation.

However, in the case of above-mentioned example 1 of prior art, a secondary page is represented on the display only when the switch is pushed down (secondary condition). So, the switch is used only for switching from one condition to another, and pen touch operation must be done every time for every page transition. Considering that a PDA may be used in mobile environment, if pen touch operation must be done for changing over the page displayed on the screen, there may be the case that it is very difficult to perform page transition depending on circumstances. Therefore, there remains a problem of poor operationality.

On the other hand, with example 2 of prior art, although the changeover of function is performed by the function switches, the function switches changeover only functions, and pen touch operation is necessary when performing the transition of hierarchial pages. In this case also there may be the case that it is very difficult to perform page transition depending on circumstances and there remains a problem of poor operationality, considering that the equipment may be used in mobile environment.

Further, it is desirable to adopt the page transition peculiar to jog dial in order to perform rapid processing in mobile environment. However, there are many varieties of page transition to be performed by pen touch operation, and it is not easy to reach a desired operation page by operating the jog dial in mobile environment, although several varieties of page transfer similar to that done by pen touch operation can be performed by the operation of the jog dial.

### SUMMARY OF THE INVENTION

The object of the present invention is to provide a personal digital assistance extremely superior in operationality and the program to be used therefore.

According to the present invention, a personal digital assistant can be provided, which is provided with a display part capable of displaying various operation pages and in which the operation page displayed on said display part can be transitioned to another operation page in accordance with the touch operation to the operation page displayed on said display part, wherein are provided;

a control switch which is supported to be able to be turned and pushed-in and which sends out an operation signal in response to the turning or pushing operation of the same,

a judging means which judges whether the touch operation to said display part is done or said control switch is operated,

a display control means which performs, when said judging means judges that the touch operation is done to said display part, the first page transition control for transitioning the operation page displayed on said display part in accordance with said touch operation, and which judges when receiving said operation signal that said control switch is operated and performs the second page transition control for transitioning the operation page displayed on said display part in accordance with said operation signal.

As described above, page transition is controlled differently by the operation of the control switch and touch operation, namely, by the touch operation the operation page is transitioned by the first page transition operation control, and by the operation of the control switch the operation page is transitioned by the second page transition operation control. Therefore, it is possible, for example, to allow the limited page transition suitable in mobile environment to be done by the operation of the control switch, on the other hand to allow all the page operation to be done by the touch operation. As a result, by dividing the page transition in two category, the operationality of the PDA can be extremely improved.

In the present invention, a plurality of items are displayed on said operation page as selection items, and said display control means performs, when it is judged by said judging means that the turning operation of said control switch is done, the selection of an item from said selection items in accordance with the turning operation signal and then, when it is judged that the pushing operation of said control switch is done, the second page transition control whereby the page is transitioned to the operation page pertinent to the item selected in accordance with the turning operation signal. By the way like this, the transition of operation pages can be easily performed.

In the present invention, said display control means allows, when said judging means judges that turning operation is done to said control switch, the cursor to move on the operation page in the direction corresponding to the turning direction of said control switch in accordance with the turning operation signal. In this way, the turning direction of the control switch, more specifically the direction of the movement of the thumb of the operator can be matched with the shift direction of the cursor, which results in good operationality.

In the present invention, said display control means performs, when said judging means judges that the turning operation of said control switch is done, the selection of an item from the predetermined selection items among the items displayed in said operation page as selection items and then, when it is judged that the pushing operation of said control switch is done, the second page transition control is performed whereby the page is transitioned to the operation page pertinent to said selected item. By the way like this, it is possible to allow the selection of fundamental items from the selection items and its execution by the operation of the control switch, and by combining the control switch operation with the touch operation the operationality in mobile environment, etc. can be improved.

In the present invention, said display control means allows the cursor to move on the operation page in accordance with the turning operation of said control switch and performs the second page transition control to changeover to the page determined by the position of the cursor by the pushing operation of said control switch. As the page to be transitioned to is determined by the turning and pushing operation of the control switch, the operationality when performing page transition is improved.

In the present invention, said control switch is supported on a shaft extending in a certain direction so that the same is rotatable in a certain range of angle from a reference position of rotation and can be pushed-in to the direction perpendicular to the direction of rotation at said reference position of rotation. As the range of turning of the control switch is defined and the control switch always comes back to the reference position, the operationality, for example when shifting the cursor, is improved.

In the present invention, said display part is positioned on the front face of the encasement of the personal digital assistant, and said control switch is located on the side of the encasement of the personal digital assistant such that said shaft for supporting the control switch extends in the direction toward the rear face of the encasement of the personal digital assistant from the front face thereof. As the control switch is located on the side of the encasement and the display part is positioned on nearly all over the front face of the encasement, a large area of display part can be secured with the small size of digital personal assistant and moreover the digital personal assistant can be held by one hand and the control switch can be operated by said hand.

In the present invention, an escape switch is provided on the side of the encasement of the personal digital assistant, and when said escape switch is pushed said display control means carries out page return from the operation page after transition to the page before transition. In this way, the returning to the page before transition can be easily done only by pushing the escape switch without operating the control switch.

According to the present invention, a personal digital assistant cab be provided, which is provided with a touch panel, an operation page being displayed on the touch panel, the page on the touch panel being transitioned in accordance with the touch operation to said operation page, wherein are provided; a control switch which is supported to be able to be turned and pushed-in and which sends out an operation signal in response to the turning or pushing operation of the same, a judging means for judging which of said touch operation to said display part or said control switch operation is done, a display control means which performs, when said judging means judges that said display part is touched, the changeover to the first operation page suited for the touch operation and which performs, when receiving said control switch operation signal, the changeover to the second operation page suited for the control switch operation.

According to the present invention, a personal digital assistant can be provided, which is provided with a touch panel and an input operation part, in which a variety of operation pages can be selectively displayed on the touch panel, the operation page displayed on the touch panel being able to be transitioned in accordance with the touch operation to the operation page, or the operation for said input operation wherein said input operation part is composed at least of a control switch which is supported so that the same is rotatable in a certain range of angle and can be pushed-in and wherein are provided; a judging means for judging which of the touch operation to said display part or the control switch operation is done, and a display control means which performs, when said judging means judges that said display part is touched, the changeover to the first operation page suited for the touch operation and which performs, when receiving the control switch operation signal, the change over to the second operation page suited for the control switch operation.

According to the present invention, a personal digital assistant provided can be provided, which is provided with a touch panel and an input operation part, in which a variety of operation pages each having a plurality of selection items can be selectively displayed on said touch panel, the operation page on the touch panel being able to be transitioned in accordance with the touch operation touching to the position of an arbitrary item among the selection items displayed on the touch panel or in accordance with the operation of selecting and determining an arbitrary item from the selection items conducted by the operation in said input operation part, wherein said input operation part is composed at least of a control switch which is supported so that the same is rotatable in a certain range of angle and can be pushed-in and wherein are provided; a selection item determining means for selecting an arbitrary item from the selection items displayed on the touch panel by the control switch turning operation and determining said selected item by the control switch pushing operation, a judging means for judging which of the touch operation to said display part or the control switch operation is done, and a display control means which performs, when said judging means judges that the touch operation is done to the touch panel, the changeover to the first operation page having the arrangement of selection items suited for the touch operation and which performs, when said judging means judges that the operation of said control switch is done, the changeover to the second operation page having the arrangement of selection items suited for the control switch operation.

In the present invention, said display control means allows said selection items to be arranged in two-dimensional arrangement (arrangement in a plurality of columns) in the first operation page and to be arranged in one-dimensional arrangement (arrangement in one column) in the second operation page.

According to the present invention, a personal digital assistant can be provided, which is provided with a touch panel and an input operation part, in which a variety of operation pages each having a plurality of selection items can be selectively displayed on said touch panel, the operation page on the touch panel being able to be transitioned in accordance with the touch operation touching to the position of an arbitrary item among the selection items in the page displayed on the touch panel or in accordance with the operation of selecting and determining an arbitrary item from the selection items conducted by the operation in said input operation part, wherein said input operation part is composed at least of a control switch which is supported so that the same is rotatable in a certain range of angle and can be pushed-in and wherein are provided; a selection item determining means for selecting an arbitrary item from the selection items displayed on the touch panel by the control switch turning operation and determining said selected item by the control switch pushing operation, a judging means for judging which of the touch operation to said display part or the control switch operation is done, and a display control means which performs, when said judging means judges that the touch operation is done to the touch panel, the changeover to the first operation page in which are arranged detailed selection items suited for the touch operation and which performs, when said judging means judges that the pushing operation of said control switch is done, the changeover to the second operation page in which are arranged simple selection items suited for the control switch operation.

According to the present invention, a personal digital assistant can be provided, which is provided with a touch panel and an input operation part, in which a variety of operation pages each having a plurality of selection items can be selectively displayed on said touch panel, the operation page on the touch panel being able to be transitioned in accordance with the touch operation touching to the position of an arbitrary item among the selection items displayed on the touch panel or in accordance with the operation of selecting and determining an arbitrary item from the selection items conducted by the operation in said input operation part, wherein

said input operation part is composed at least of a control switch which is supported so that the same is rotatable in a certain range of angle and can be pushed-in, and wherein are provided; a selection item determining means for selecting an arbitrary item from the selection items displayed on the touch panel by the control switch turning operation and determining said selected item by the control switch pushing operation, a judging means for judging which of the touch operation to said display part or the control switch operation is done, and a display control means which performs immediately, when said judging means judges that the touch operation is done to the touch panel, the changeover to the first operation page of the layer under the operation page under display and which performs, when said judging means judges that the operation of said control switch is done, the changeover first to the second operation page of the layer under the operation page under display and then to said first operation page in accordance with the operation of the control switch.

According to the present invention, a personal digital assistant can be provided, which is provided with a touch panel and an input operation part, in which a variety of operation pages each having a plurality of selection items can be selectively displayed on said touch panel, the operation page on the touch panel being able to be transitioned in accordance with the touch operation touching to the position of an arbitrary item among the selection items displayed on the touch panel or in accordance with the operation of selecting and determining an arbitrary item from the selection items conducted by the operation in said input operation part, wherein said input operation part is composed at least of a control switch which is supported so that the same is rotatable in a certain range of angle and can be pushed-in and wherein are provided; a selection item determining means for selecting an arbitrary item from the selection items displayed on the touch panel by the control switch turning operation and determining said selected item by the control switch pushing operation, a judging means for judging which of said the touch operation to said display part or said control switch operation is done, and an execution control means which carries out, when said judging means judges that the touch operation is done to the touch panel, the execution of various functions and various setting in accordance with an arbitrary selection item on the touch panel touched by the touch operation and which carries out, when said judging means judges that the operation of said control switch is done, only the execution of various functions in accordance with an arbitrary selection item selected and determined by the operation of the control switch.

According to the present invention, a page transition control program can be provided, which operates in the personal digital assistant and which comprises;

a judging step for judging whether a control switch supported so that the same is rotatable in a certain range of angle and can be pushed-in is operated or the operation page displayed on a display part where a variety of operation pages can be selectively displayed is touched, a first page transition control step for performing the first page transition control by which the operation page displayed on said display part is transitioned in accordance with the touch operation when it is judged that said display part is touched, and a second page transition control step for performing the second page transition control by which the operation page displayed on said display part is transitioned in accordance with the control switch operation when it is judged that the control switch is operated.

### BRIEF DESCRIPTION OF THE DRAWINGS

The invention is illustrated by way of example and not limitation and the figures of the accompanying drawings in which like references denote like or corresponding parts, and in which:

FIG. 1 is a oblique perspective view showing the external appearance of the personal digital assistant according to the present invention.

FIG. 2 is the block diagram of an example of control system used in the personal digital assistant shown in FIG. 1.

FIG. 3 is an illustration showing page transition in schedule pages by pen touch operation in the personal digital assistant shown in FIG. 1.

FIG. 4 is an illustration showing page transition in schedule pages by side controller (control switch) operation in the personal digital assistant shown in FIG. 1.

FIG. 5 is an illustration showing page transition in mail pages by pen touch operation in the personal digital assistant shown in FIG. 1.

FIG. 6 is an illustration showing page transition in mail pages by side controller operation in the personal digital assistant shown in FIG. 1.

FIG. 7 is an illustration showing page transition in address book pages by pen touch operation in the personal digital assistant shown in FIG. 1.

FIG. 8 is an illustration showing page transition in address book pages by side controller operation in the personal digital assistant shown in FIG. 1.

FIG. 9 is an illustration for explaining page transition in schedule application pages.

FIG. 10 is an illustration for explaining page transition in mail application pages.

FIG. 11 is an illustration for explaining page transition in address book application pages.

FIG. 12 is an illustration for explaining page transition in file case application pages.

FIG. 13 is an illustration for explaining page transition in memorandum book application pages.

FIG. 14 is an illustration for explaining page transition in one-dimensional and two-dimensional arrangement of items in a menu page.

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

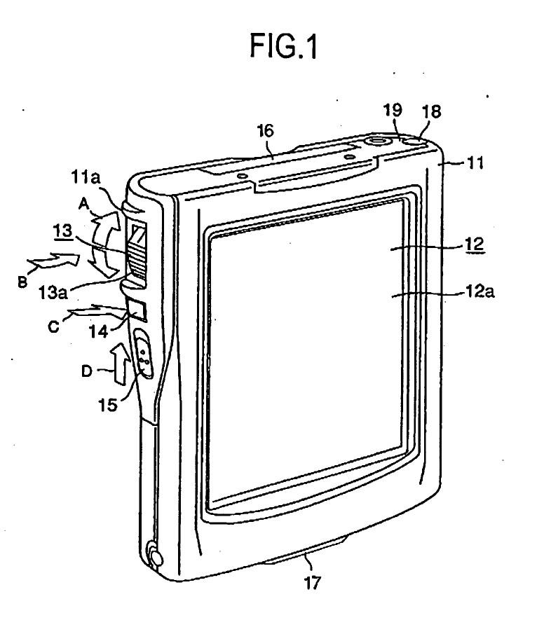

The first embodiment will be explained referring to FIG. 1. The personal digital assistant (PDA) shown in the drawing is of a size held on the palm of the hand. A liquid crystal display panel 12 with a touch panel 12a spreading nearly all over the surface thereof is located in the front of the encasement of the PDA. (Said touch panel 12a is, for example, laid on the surface of the liquid crystal display panel 12.) Further, the encasement 11 is provided with a control switch 13 (hereafter referred to as a side controller), an escape switch 14, power source ON/OFF switch 15 (hereafter referred to as a power switch), an insert slot 16 into which an external memory is inserted, an external connection terminal 17 used when sending and receiving data, and accommodation part 19 for accommodating a touch pen 18 (stylus pen).

As shown in FIG. 1, the side controller 13, escape switch 14, and power switch 15 are located arranged in a row on the side of the encasement 11. In the case of the example shown in the drawing, they are located in the order of the side controller 13, escape switch 14, and power switch 15 from the upper part of the encasement. The side controller 13 is located in the position where the thumb of the left hand probably comes when, for example, the encasement 11 is held by the left hand so that the liquid crystal display panel 12 is in the upright position.

A projection 11a is formed above the side controller 13 extending toward outside, and part of the side controller 13 is exposed in the side of the encasement 11. The side controller 13 is supported on a shaft (not shown) extending from the front face of the encasement 11 toward the rear face thereof so that the same is rotatable in the rotation directions shown by arrow A in a certain range of angle and can be pushed-in to the direction perpendicular to said shaft (direction from the outside to the inside of the encasement) as shown by arrow B. The range of rotation is restricted to the extent that the side controller 13 is rotated by one upward and downward stroke of the thumb of the left hand. The exposed portion of the side controller 13 is, for example, serrated as indicated by 13a.

As mentioned above, the side controller 13 can be turned or pushed-in by, for example, the thumb of the left hand touching the serrated portion 13a. The side controller 13 is positioned in a predetermined position of rotation (hereafter referred to as the reference position) when the same is not operated. When the side controller 13 is rotated by a certain angle by the upward stroke of the thumb of the left hand, the same can not be rotated further. When the thumb of the left hand is removed from the side controller 13, that means when the force to turn the side controller 13 is removed, the side controller 13 returns automatically to the reference position.

Similarly, when the side controller 13 is rotated by a certain angle by the downward stroke of the thumb of the left hand, the same can not be rotated further. When the thumb of the left hand is removed from the side controller 13, the side controller 13 returns automatically to the reference position. The side controller 13 can be pushed-in only when the same is at the reference position. As the side controller 13 is operated by the thumb of the left hand holding the PDA as described above, the movement of the thumb is restricted and complicated operation of the same is difficult, so the side controller 13 is supported to be able to be turned in a clockwise and counterclockwise direction in a restricted range from the reference position and pushed-in only at the reference position. When the force to push in the side controller is removed, the same returns automatically to the original reference position.

The side controller 13 sends operation signals in accordance with said turning or pushing operation. A variety of processing is carried out in accordance with the signals as mentioned later.

As mentioned before, the escape switch is located under the side controller 14, under the escape switch 14 is located the power switch 15, and a plurality of point-protrusions are formed on the surface of the power switch 15. These side controller 13, escape switch 14, and power switch 15 are located in the position where they can be operated by the left hand. In the example shown in the drawing, the escape switch 14 is operated by pushing it (in the direction of arrow C), by this an escape signal (ESC) is sends out, and escape action is executed as mentioned later. The power switch 15 is operated by sliding it (in the direction of arrow D). The power is switched on when the power switch 15 is slid up in the drawing, and it returns to the original position when the sliding up operation is released. When the power switch 15 is slid up in the state the power is switched off the power is switched on and the power switch 15 returns to the original position when sliding up operation is released.

The PDA shown in the drawing can carry out data transmission/reception to or from a personal computer, etc. by connecting with, for example, a specialized charging equipment (so-called cradle equipment) having communications capabilities by way of the external connection terminal 17. Further the PDA can be charged through the external connection terminal. The liquid crystal display panel 12 is, for example, a color liquid crystal display panel, and backlighting is provided as necessary. The touch panel 12a has a touch sensor for detecting the touched position and trail, etc. when the panel is touched with the touch pen 18.

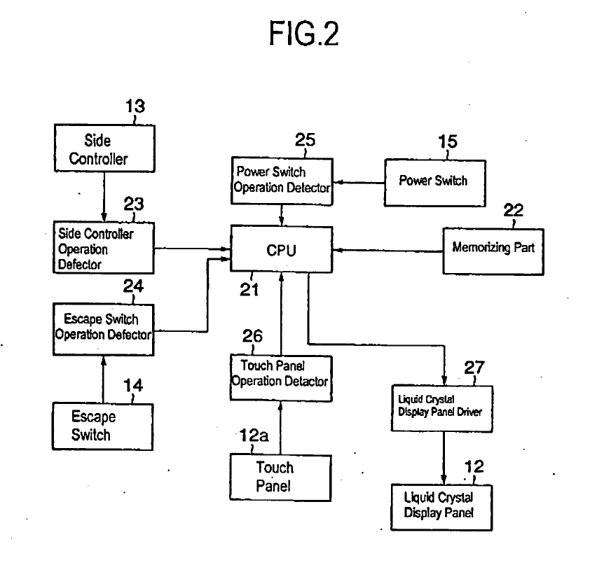

Next, referring to FIG. 2, the PDA shown in FIG. 1 has a central processing unit (CPU) 21 which controls the PDA in correspondence with the programs accommodated in a memorizing part 22 such as ROMs and carry out a variety of processing described later according to the application programs accommodated in the memorizing part 22. There may be the case application programs are taken in from the external memory carrying medium inserted in the insert slot 16.

As shown in FIG. 2, the side controller 13 and escape switch 14 are connected to the CPU 21 respectively by way of a side controller operation detector 23 and an escape switch operation detector 24 the escape switch 14. To the CPU is also connected the power switch 15 by way of a power switch operation detector 25. Further, the touch panel 12a and a liquid crystal display panel 12 are connected to the CPU respectively by way of a touch panel operation detector and a liquid panel driver 27.

When the power switch 15 is pushed up in the state the PDA is shut off with power source, the power switch operation detector 25 detects the push-up operation and sends a power switch operation signal to the CPU 21. The CPU 21 responses to the power switch operation signal and switch on the PDA. When switched on, the CPU 21 drives and controls the liquid crystal display panel driver 27 to display o the liquid crystal display panel 12 an initial page (menu page, hereafter this menu page is referred to as a launcher page).

Each of the operation to the controller 13, escape switch 14, and touch panel 12a is detected respectively by the side controller operation detector 23, escape switch operation detector 24, and touch panel operation detector 26, and each of the detected signals is sent to the CPU 21, whereby the CPU 21 judges which of the touch operation to the display part, or side controller operation, or escape switch operation is done and performs the transition control of operation page under the program accommodated in the memorizing part 22.

On the launcher page are displayed several menu items (selection items) such as, for example, mail, browser, address book, schedule, memo, file viewer, system, setting, etc. together with icons. That is, application programs (application software) pertinent to these menu items are accommodated in the memorizing part 22. In the launcher page are displayed a tool bar in the lower part and the date and time in the upper part.

When the side controller 13 is turned in a clockwise direction by sliding the thumb of the left hand upward from the reference position, the side controller operation detector 23 detects this operation and sends the signal of upward operation to the CPU 21. Upon receiving the signal, the CPU 21 allows the cursor to be moved upward in the launcher page. When the side controller 13 is turned in a counterclockwise direction by sliding the thumb of the left hand downward from the reference position, the side controller operation detector 23 detects this operation and sends the signal of downward operation to the CPU 21. Upon receiving the signal, the CPU 21 allows the cursor to be moved downward in the launcher page. When the side controller 13 is pushed-in after the cursor is positioned in one of the menu items, the side controller operation detector 23 detects the pushing operation and sends the signal of pushing operation. Upon receiving the signal, the CPU 21 allows the menu item where the cursor is positioned to be selected and the application program pertinent to the selected item to be started to transition the page on the display to the operation page pertinent to the selected menu item.

When one of the selection items in the launcher page displayed on the touch panel 12a is touched by the touch pen, the touching is detected by the touch panel operation detector 26 and the signal of touching operation is send to the CPU 21. Upon receiving the signal, the CPU 21 allows the application program pertinent to the selected item to be started to transition the page on the display to the operation page pertinent to the selected menu item.

Like this way, the CPU 21 judges which of touch operation or side controller operation is done and allows above mentioned processing to be carried out according to the result of judgment. In the explanation below, various icons, buttons, etc. are included in the selection items as well as the menu items.

Here will be explained page transition concretively in the case schedule, mail, or address book is selected as a menu item. In the explanation described hereunder, page transition control is performed under the programs running on the CPU 21. The CPU 21 carries out the first page transition control for each application program when touch operation is done with the touch pen, and the same carries out the second page transition control for each application program when the side controller 13 is operated.

First, the transition of operation page (hereafter the operation page is referred to as the displayed page or simply page) will be explained taking the case of schedule as an example.

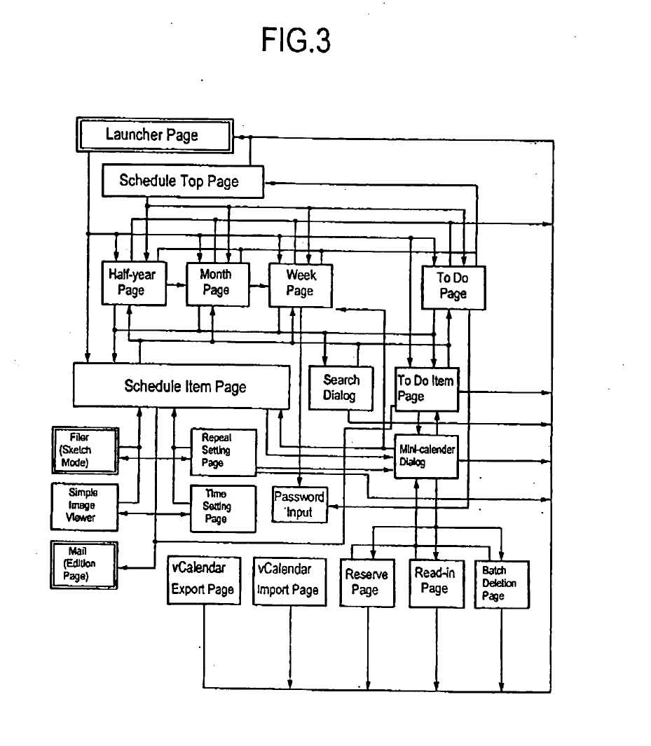

Referring to FIG. 3, in the state the launcher page is displayed, when ‘schedule’ among the menu items is touched, the application program pertinent to schedule is started and the page that had been displayed at the end of previous operation. That is, the lastly displayed page among the pages displaying half-yearly, monthly, weekly, and to-do schedule is displayed as is described later. Then, in these pages, when menu icon, end button (indicated with x mark), or file-end in the function icon as is described later is touched, the page is transitioned to the launcher page. Further, in these pages, when return icon as is described later is touched, the page is transitioned to the schedule top page.

The schedule top page is a menu page pertinent to schedule. In the schedule top page are displayed the columns of half-yearly display, monthly display, weekly display, and to-do (the task to be done) display, and also tool bar and the date and time are displayed. Further, in the schedule top page are displayed a scroll button, menu key, return icon, return key, and backlight icon (these are not shown in the drawing).

Now, when the half-yearly display column is touched in the schedule top page, the half-yearly schedule page (half-year page) which shows a calendar for a half year is displayed on the liquid crystal display panel 12. Similarly, when the monthly display column is touched in the schedule top page, the calendar of current month is displayed on the liquid crystal display panel 12 as a month schedule page (month page). When the weekly display column is touched in the schedule top page, the calendar of current week is displayed on the liquid crystal display panel 12 as a week schedule page (week page). Further, when to-do display column is touched in the schedule items displaying page, the list of the tasks to be controlled of their progresses is displayed on the liquid crystal display panel 12 as a to-do schedule page (to-do page).

In each of above mentioned pages are displayed a tool bar, the date and time, menu key, return icon, and backlight icon as well as a half-year key, month key, week key, to-do key, and produce key.

The half-yearly key is darkened in the half-year page, and when the monthly key is touched in the half-year page, the page is transitioned to the month page. When the weekly key is touched in the month page, the page is transitioned to the week page. When the to-do key is touched in the half-year page, the page is transitioned to the to-do page. Further, when any one of months in the half-year page is touched, the page is transitioned to the month page of the touched month. Further, a scroll key is displayed in the half-year page, and every time the scroll key is touched, the calendar is scrolled by three months.

When the menu key is touched in the half-year page, the page is transitioned to the launcher page. When the produce key is touched in the half-year page, the page is transitioned to a schedule item page (to-do item page) on which schedule edition can be done. When return icon is touched in the half-year page, the page is transitioned to the schedule top page.

Similarly, in the month page, the monthly key is darkened and when the half-yearly key, weekly key, or to-do key is touched, the page is transitioned respectively to the half-year page, week page, or to-do page. Further, when any one of the weeks is touched in the month page, the page is transitioned to the week page of the touched week. When return icon is touched in the half-year page, the page is transitioned to the schedule top page. Page transitions in the week page and to-do page are similar, except that even if the day of the date is touched the page is not transitioned to the to-do page. When return icon is touched in the schedule edition page, the page is transitioned to the immediately preceding page.

Further, in the half-year page, month page, week page, and to-do page, when the function icon is touched and then ‘search’ is touched, the page is transitioned to search dialog page. When any one of the determination button, cancel button, return icon is touched, the page is transitioned to the page (half-year page, month page, week page, or to-do page) displayed immediately before.

On the other hand, in the schedule item page, when the repeat button is touched the page is transitioned to a repeat setting page and when clock button is touched a time setting dialog box is displayed. In addition, when image designation button is touched, a filer (sketch mode) which is another application is started and the page is transitioned to a filer page. When the image part is touched in the schedule item page, a simple image viewer is displayed. Further, when the mail button is touched in the schedule item page, the mail application which is another application is started and the page is transitioned to a mail page (edition page). When the calendar button is touched in the to-do item page, a mini-calendar dialog box is displayed.

Transition to a vCalendar export page, vCalendar import page, reserve page, read in page, batch deletion page, etc. can be performed using said function icon. When the cancel button or return icon is touched in these pages, the page is transitioned to the page displayed immediately before.

As described above, not only the transition to a variety of pages but also to another application page can be performed in the schedule application by the touch operation, thus page transition can be performed in detail.

By the way, as a PDA is used in mobile environment, it may be inconvenient to use the touch pen (stylus pen). Therefore, it is devised in the PDA shown in FIG. 1 that fundamental operation can be performed with the side controller 13.

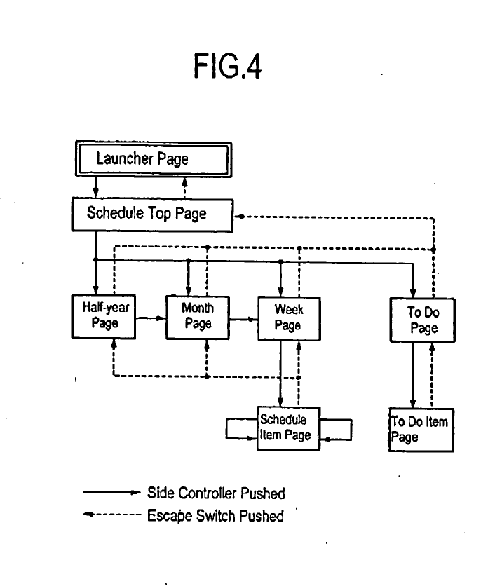

Referring to FIG. 4, when the side controller 13 is turned to move the cursor to be positioned at the schedule in the menu items when the launcher page is displayed and then pushed-in, the schedule top page is displayed on the liquid crystal display panel 12. When the side controller 13 is turned when the schedule top page is displayed, the cursor moves on the half-yearly display column, monthly display column, weekly display column, and to-do column. When the cursor is moved to the position of the half-yearly display column and then the side controller 13 is pushed-in, the half-year page is displayed. Similarly, when the cursor is moved to the position of the monthly display column, weekly display column, or to-do column and then the side controller 13 is pushed-in, the month page, week page, or to-do page is displayed respectively. On the other hand, when the escape switch is pushed-in in the state the half-year page, month page, week page, or to-do page, the page is transitioned to the schedule top page.

Further, when the side controller 13 is pushed-in when the half-year page is displayed, the page is transitioned to the month page. When the side controller 13 is pushed-in when the month page is displayed, the page is transitioned to the week page. When the side controller 13 is pushed-in when the week page is displayed, the page is transitioned to the schedule item page. When the side controller 13 is pushed-in when the schedule item page is displayed, the changeover between the base item tab and extension item tab is done. When the escape switch is pushed-in the schedule item page, the page is transitioned to the page (week page) displayed immediately before.

On the other hand, when the side controller 13 is pushed-in in the state the to-do page is displayed, to-do item page is displayed. When the escape switch 14 is pushed when the to-do page is displayed, the page is transitioned to the to-do page.

In the way like this, fundamental page transition can be performed by operating the side controller 13, and the fundamental scheduling ring can be ascertained with one hand (left hand) without using the touch pen.

Next, the page transition by the operation of touch pen 18 will be explained taking the case of mail as an example.

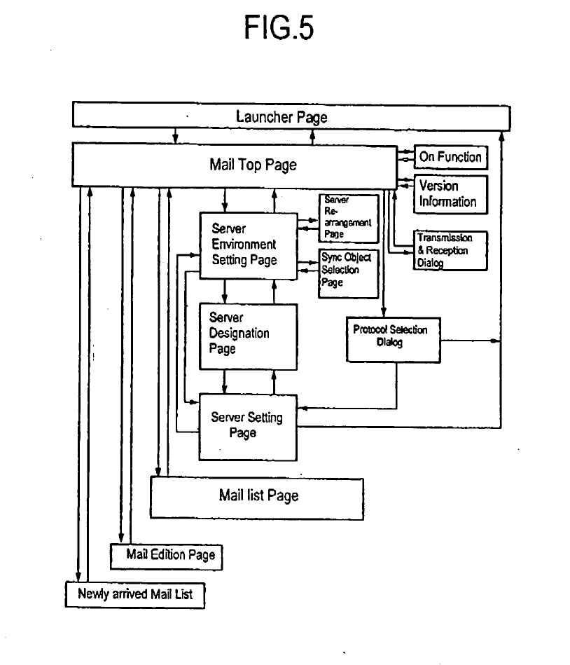

Referring to FIG. 5, when ‘mail’ among the menu items is touched in the state the launcher page is displayed, the application program pertinent to mail is started and mail top page is displayed. When the return icon or end button is touched, the page is transitioned to the launcher page. Now, when any one of the menu items in the mail top page (for example, list of newly-arrived mail, mail writing, mail list, batch transmission and reception, draft, and server environment setting) is touched in the case server setting is not finished, a protocol selection dialog box is displayed. Then, when OK button is touched in the top page, the page is transitioned to a server environment setting page. On the other hand, cancel button is touched in the protocol selection dialog box, the page is transitioned to the launcher page. If the cancel button or end button is touched in the server environment setting page even if server setting is not done, page is transitioned to the launcher page.

After server setting is finished, when ‘newly-arrived mail list’ in the menu items is touched the page is transitioned to newly-arrived mail list page, and when the return icon in the newly-arrived mail list page is touched the page is transitioned to the mail top page. Similarly, when ‘mail writing’ is touched the page is transitioned to the mail edition page, and when the return icon in the mail edition page is touched the page is transitioned to the mail top page. Further, when ‘mail list’ or ‘draft’ in the mail top page is touched, the page is transitioned to the mail list page, and when the return icon in the mail list page is touched, the page is transitioned to the mail top page.

In addition, when ‘server environment setting’ in the mail top page is touched, the page is transitioned to the server environment setting page. When ‘sever rearrangement’ is touched in the server environment setting page, the page is transitioned to the server rearrangement page, on which server rearrangement is possible. When the designation button, return icon, or cancel button in the server rearrangement page is touched, the page is returned to the server environment setting page.

When ‘server setting’ is touched in the server environment setting page in the case there are a plurality of sever settings, the page is transitioned to the server designation page. Similarly, when ‘server deletion’ is touched, the page is transitioned to the server designation page. The designation or deletion of server is done in the server designation page. When sever designation is done, the server setting page is displayed. When the return button or cancel button is touched in the server setting page, the page is transitioned to the server designation page.

Now, in the case of one server setting, when ‘server setting’ is touched in the server environment setting page, the page is transitioned to the server setting page. Then, when the return button or cancel button is touched in the server setting page, the page is transitioned to the server environment setting page.

In the mail top page, when ‘on function’ in the menu is touched, the page is transitioned to the page concerning function, and when OK button is touched here, the page returns to the mail top page. Further, in the mail top page, when ‘version information’ in the menu is touched, the page is transitioned to the page concerning the version information, and when OK button is touched here, the page returns to the mail top page. In addition, when ‘sync object’ is touched in the server environment setting page in the case there is are a plurality of server settings, the page is transitioned to the synchronization object selection page. When the determination button or cancel button is touched here, the page is transitioned to the server environment setting page. When the batch transmission and reception is touched in the mail top page, the transmission and reception dialog box is displayed. When the cancel button is touched in the transmission and reception dialog box, the page is transitioned to the mail top page. In the way like this, displaying of a variety of pages can be performed also in the mail function.

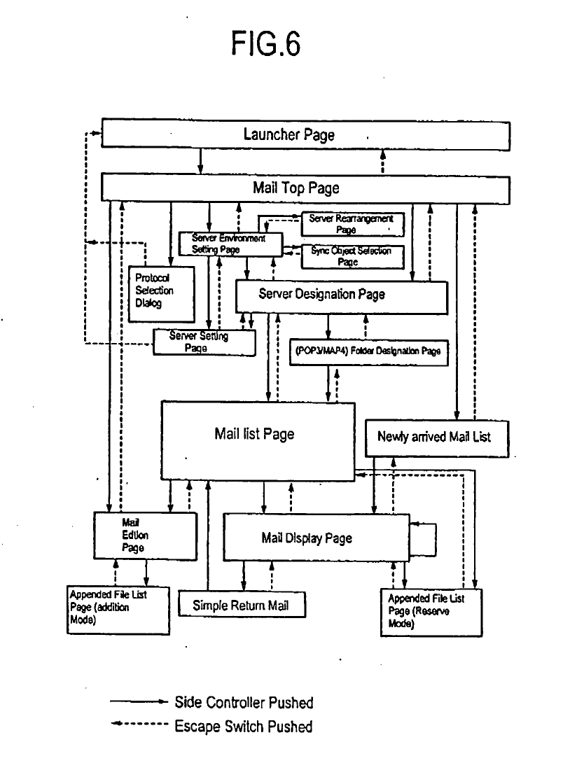

Next, the page transition by the operation of the side controller will be explained taking the case of mail as an example. Referring to FIG. 6, now in the state the launcher page is displayed, when the side controller 13 is turned to select ‘mail’ among the menu items and then the side controller 13 is pushed-in, the application pertinent to mail is started and the mail top page is displayed. When the escape switch is pushed-in the top page, the page is transitioned to the launcher page. Now, when any one of the menu items in the mail top page (for example, list of newly-arrived mail, mail writing, mail list, batch transmission and reception, draft, and server environment setting) is selected by turning the side controller 13 and the same is pushed-in in the case server setting is not finished, a protocol selection dialog box is displayed. Then, when the escape switch 14 is pushed, the page is transitioned to the launcher page.

After server setting is finished, when ‘mail writing’ is selected by turning the side controller 13 and then the same is pushed-in, the page is transitioned to the mail edition page, and when the escape switch 14 is pushed the page is transitioned from the mail edition page to the mail top page. When ‘server environment setting’ is selected by turning the side controller 13 and then the same is pushed-in, the page is transitioned to the server environment setting page. When the escape switch 14 is pushed-in the server environment setting page, the page returns to the mail top page. On the other hand, in the case there are a plurality of server settings, when ‘server deletion’ or ‘server setting’ in the server setting page is selected by turning the side controller 13 and then the same is pushed-in, the page is transitioned to the server designation page. When the escape switch is pushed when the server designation page is displayed, the page returns to the server environment setting page. When the cursor is moved by turning the side controller 13 to select a server and then the side controller 13 is pushed-in, the page is transitioned to the server setting page. When the escape switch 14 is pushed when the server setting page is displayed, the page returns to that displayed immediately before.

On the other hand, in the case one server is designated, when ‘server designation’ is selected by turning the side controller 13 and then the same is pushed-in, the page is transitioned to the server designation page. When the escape switch 14 is pushed when the server designation page is displayed, the page returns to the server environment setting page which is the immediately preceding page. When the server setting is not finished, the page is transitioned to the launcher page upon pushing the escape switch.

When ‘server rearrangement’ is selected by turning the side controller 13 and then the same is pushed-in, the page is transitioned to the server rearrangement page. When the escape switch is pushed when the server rearrangement page is displayed, the page returns to the server environment setting page.

Now, in the main top page, when ‘draft’ or ‘mail list’ is selected by turning the side controller 13 and then the same is pushed-in when the mail top page is displayed, the page is transitioned to the server designation page. When the escape switch is pushed when the server designation page is displayed, the page is transitioned to the mail top page displayed immediately before. In the state ‘mail list’ is selected and transitioned to the server designation page, when ‘server’ is selected by turning the side controller 13 and then the same is pushed-in, the page is transitioned to the folder page. When desired folder in the folder page is selected and then the side controller 13 is pushed-in, the mail list pertinent to the selected folder is displayed. When the mail that the user want to read (transmitted mail or received mail) is selected and then the side controller 13 is pushed-in, the page is transitioned to the mail page. When the side controller is pushed during the period longer than a predetermined period (long period pushing-in) when the mail page (received mail mode) is displayed, the page is transitioned to a simple return mail mode, and the return mailing for the mail selected in the simple return mail page is possible.

When the escape switch 14 is pushed when the simple return mail page is displayed, the page is transitioned to the mail page. When the escape switch 14 is pushed when the mail gage is displayed, the page is returned to the folder designation page. When the escape switch 14 is pushed when the folder designation gage is displayed, the page is returned to the server designation page. When the side controller 13 is pushed-in in the case the page is transitioned to the server designation page by selecting ‘draft’, the page is transitioned to the mail list page. When the escape switch 14 is pushed then, the page is returned from the mail list to the server designation page. When the side controller 13 is pushed-in when the simple mail page is displayed, mail transmission is carried out and after the transmission the page is transitioned to the mail list.

On the other hand, when ‘draft mail’ or ‘return mail reservation’ is selected by turning the side controller 13 and then the same is pushed-in, the page is transitioned to the mail edition page. When the escape switch is pushed then, the page is returned to the mail list page.

Further, When ‘newly arrived mail list’ is selected by turning the side controller 13 and then the same is pushed-in when the mail top page is displayed, the page is transitioned to the newly arrived mail list page. When the desired mail is selected by turning the side controller 13 and then the same is pushed-in when the newly arrived mail list page is displayed, the page is transitioned to the mail page. When the escape switch 14 is pushed then, the page is returned to the newly arrived mail list. When the side controller 13 is pushed-in when the newly arrived mail list page is displayed, the mail top page is restored. When the side controller 13 is pushed-in when the mail page is displayed, the succeeding mail is displayed in order.

In addition, in the case there are a plurality of server settings, when ‘sync object’ is selected by turning the side controller 13 and then the same is pushed-in when the server environment setting page is displayed, the page is transitioned to the sync object page. When the escape switch 14 is pushed then, the page is returned to the server environment setting page. It is possible by turning the side controller 13 to transition from the mail list page to the appended file list page (reserve mode) and by pushing the escape switch to return from the appended file list page (reserve mode) to the mail list page. The appended file list page can be transitioned from the mail page (by the pushing of the side controller), in this case, when the escape switch is pushed, the page is returned from the appended file list page to the mail page. Similarly, it is possible by turning the side controller 13 to transition from the mail edition page to the appended file list page (addition mode). In this case, when the escape switch is pushed, the page is returned from the appended file page (addition mode) to the mail edition page.

In this way, transition to various pages is easily possible even in mobile environment using the side controller and escape switch, and, for example, the mail function can be easily used outdoors without doing touch operation.

Next, the page transition by the touch operation with the touch pen 18 will be explained taking the address book as an example.

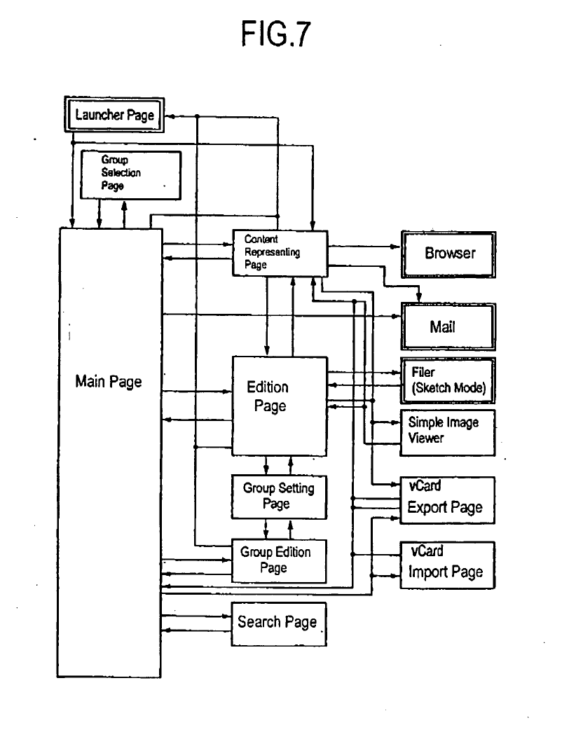

Referring to FIG. 7, now in the state the launcher page is displayed, when ‘address book’ among the menu items is touched, the application program pertinent to the address book and a main page or a content representing page is displayed. (Here, among the main page and the content representing page, the page displayed at the nearest time to the end of the preceding operation is displayed.) Now, it is assumed that the main page is displayed. When the return icon is touched in the main page, the page is transitioned to a group selection page. When a group name is touched in the group selection page, the page is transitioned to the main page. When ‘end’ or end button is touched in the main page, the page is returned to the launcher page. When a personal data is touched in the main page, the page is transitioned to the content representing page. When the return icon is touched in the content representing page, the page returns to the main page.

Further, ‘send mail’ among the function icons is touched in the main page, the mode is changed to mail mode and the application pertinent to mail is started. When ‘group edition’ among the function icons is touched, the page is transitioned to the group edition page. When the page is transitioned from the main page to the group edition page, if the return button or return icon is touched in the group edition page, the page is returned to the main page. When ‘search’ or the search button among the function icons is touched in the main page, the page is transitioned to a search page, and when the part other than the search page is touched in the search page, the page is returned to the main page.

On the other hand, when ‘end’ or the end button in the content representing page is touched, the page is returned to the launcher page, and when ‘edition’ or the edition button in the menu file is touched, the page is transitioned to the edition page. Further, the mail address area, mail button, or ‘send mail’ among the function icons is touched in the content representing page the mode is changed to mail mode and the application pertinent to mail is started.

When the determination button, cancel button, or return icon is touched for the renewal of personal data in the edition page, the content representing page is restored. When the produce button, or ‘produce’ or ‘edition’ in the menu is touched in the main page, the page is transitioned to the edition page. In this case, when the determination button, cancel button, or return icon is touched in the edition page, the page returns to the main page. Further, when ‘image read-in’ in the menu or the image designation button is touched in the edition page, the page is transitioned to the filer page (sketch mode), and when the determination button, cancel button, or return icon is touched in the filer page, the edition page is restored.

When the change button in the edition page is touched, the page is transitioned to the group setting page, and when the determination button or cancel button is touched in the group setting page, the edition page is restored. On the other hand, when the image part is touched in the content representing page or edition page, simple image viewer is displayed, and when the return button is touched in the simple image viewer, the immediately preceding image (content representing page or edition page) is restored. When ‘end’ or the end button in the menu is touched, the page is returned to the launcher page.

When ‘group edition’ or ‘edition’ among the function icons is touched in the group setting page, the page is transitioned to the group edition page. In this case, when the return button or return icon is touched in the group edition page, the group edition page is restored. When ‘end’ in the menu or the end button is touched in the group edition page, the launcher page is restored, and when ‘end’ in the menu, the end button, return button, or return icon is touched in the group selection page, the launcher page is restored.

Now, when URL (Uniform Resource Locator) is touched in the content representing page, the browser software is started. Further, in the content representing page, when ‘vCard export’ is touched, the page is transitioned to the vCard export page, and when ‘export end’, the cancel button, or return icon is touched in the vCard export page, the content representing page is restored. It is also possible to transition to the vCard export page from the main page, and in this case, when ‘export end’, the cancel button, or return icon is touched in the vCard export page, the page is returned to the main page. When ‘vCard import’ is touched in the main page, the page is transitioned to the vCard import page, and when ‘export end’, the cancel button, or return icon is touched in the vCard import page, the page is returned to the main page. In this way, various pages of address function can be displayed by touch operation.

Next, the page transition by side controller operation will be explained taking the address book as an example.

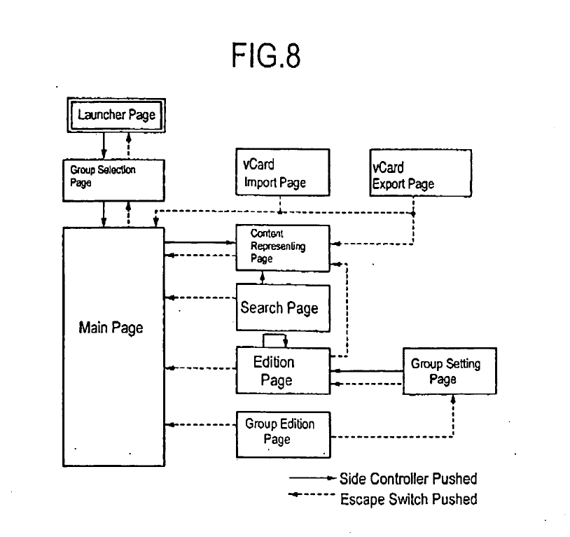

Referring to FIG. 8, now in the state the launcher page is displayed, when the side controller 13 is turned to select ‘address book’ among the menu items and then the same is pushed-in, the application program pertinent to the address book is started and the group selection page is displayed. When the escape switch 14 is pushed when the group selection page is displayed, the page is transitioned to the launcher page.

When desired group is selected by turning the side controller 13 and then the same is pushed-in, the page is transitioned to the content representing page indicating the contents pertinent to the address.

By the way, when the edition page is displayed by the touching operation mentioned above, tab transfer can be done by pushing the side controller 13, for example, in the order of telephone tab, address tab, company tab, and memo tab. When the escape switch 14 is pushed when personal data has been changed, the page is transitioned to the content representing page. On the other hand, when the escape switch is pushed when personal data has been written, the main page is restored.

When the search page is displayed by the touch operation mentioned before and the information wanted is retrieved, the information can be displayed on the content representing page by transitioning to the content representing page through pushing-in the side controller 13. Further, when the escape switch 14 is pushed when the group edition page is displayed by the touch operation mentioned before, the page returns to the page before the transition (the group setting page or main page). When the side controller 13 is pushed-in or the escape switch 14 is pushed when the group setting page is displayed, the page is transitioned to the edition page. Similarly, when the escape switch is pushed when the vCard import page is displayed, the main page is restored, and when the escape switch is pushed when the vCard import page is displayed, the page returns to the page before the transition (the content representing page or main page).

In this way, by using the side controller and escape switch, the basic page transition of address book can be done, and the displaying of contents of the address book for example can be easily performed even in mobile environment outdoors.

Next, the second embodiment will be explained.

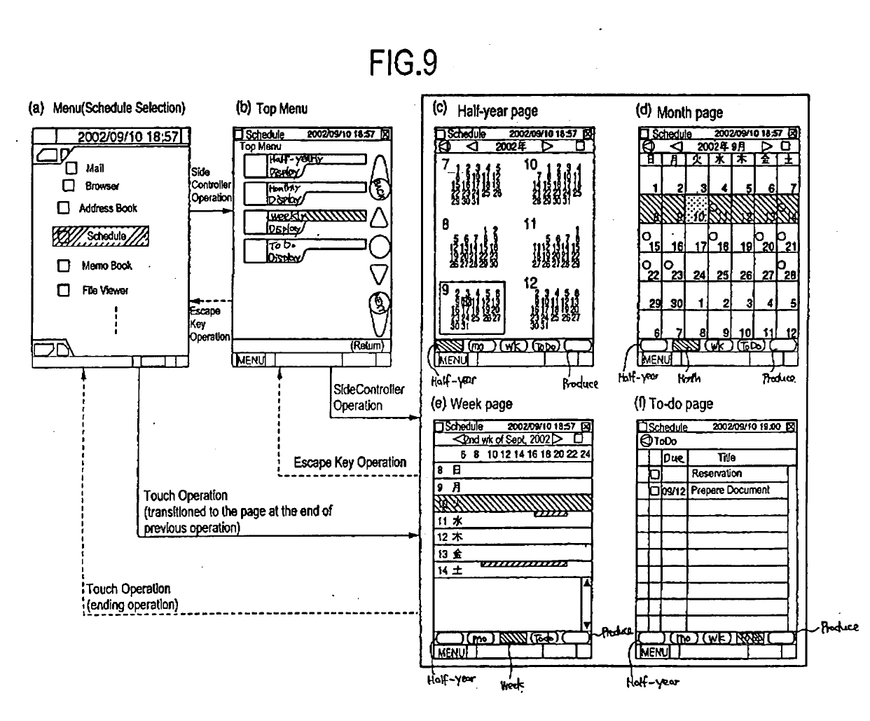

First, referring to FIG. 9, (a) shows a menu page, in which the item ‘schedule’ is shadowed meaning that the same is selected by the cursor. When it is judged that the side controller is pushed-in in this state, the page is transitioned to the top menu page (b) of the schedule application. In the top menu, an item can be selected out of the items specifying schedule representation forms and to-do form. The page selection and displaying can be done by the turning and pushing operation of the side controller or by the operation of touching the item to be selected. The schedule representation forms include a half-year page shown in (c), a month page shown in (d), and a week page shown in (e). The to-do page is shown in (f). When it is judged in the menu page that the item ‘schedule’ is touched, the page is transitioned to the page displayed at the end of the previous operation among the half-year page shown in (c), month page shown in (d), week page shown in (e), and to-do page shown in (f).

When the escape switch is pushed when the half-year page, month page, week page or to-do page shown respectively in (c), (d), (e), or (f) of page 9 is displayed, the page is transitioned to the top menu page shown in (b). This top menu page is in the state the item of the page displayed just before the transition is selected by the cursor. When it is judged that the escape switch is pushed when the top menu page is displayed, the page is transitioned to the menu page shown in (a). This menu page is in the state the item ‘schedule’ is selected. When it is judged that ‘application end’ is touched respectively in the half-year page, month page, week page, or to-do page, the page is transitioned to the menu page shown in (a). This menu page is in the state the item ‘schedule’ is selected by the cursor.

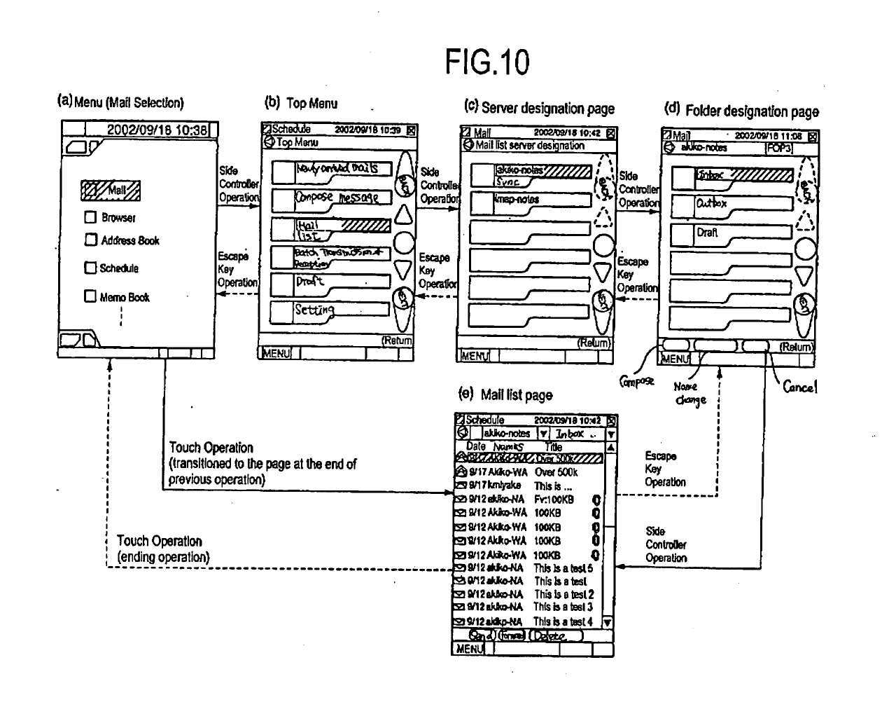

In FIG. 10, (a) shows the menu page, in which the item ‘mail’ is shadowed. In this state, when it is judged that the side controller is pushed-in, the page is transitioned to the top menu of mail shown in (b). In the top menu page there are items of ‘newly arrived mail list’, ‘mail writing’, ‘mail list’, ‘batch transmission and reception’, ‘draft’, and ‘sever environment setting’. Here the case ‘mail list’ is selected will be explained. When it is judged that the side controller is pushed-in in the state ‘mail list’ in the top menu page is shadowed, the page is transitioned to the server designation page shown in (c). This server designation page is displayed when a plurality of servers are set. In the case single server is set, the page is transitioned to the folder designation page shown in (d). When a server is selected out of a plurality of servers in the server designation page shown in (c) by turning the side controller and then it is judged that the same is pushed-in, the page is transitioned to the folder designation page shown in (d), in which are displayed folders pertinent to the server such as ‘reception box’, ‘transmission box’, ‘draft’, etc.

When a folder is selected in the folder designation page by turning the side controller and then it is judged that the same is pushed-in, the page is transitioned to the mail list page shown in (e). When it is judged in the menu page that ‘mail’ is touched, the page is transitioned to the page displayed at the end of the previous operation.

When it is judged that the escape switch is pushed when the mail list page shown in FIG. 10 (e) is displayed, the page is transitioned to the folder designation page shown in (d). This folder designation page is in the state the item of the folder which was selected in the mail list page is selected by the cursor. When it is judged that the escape switch is pushed when the folder designation page shown in (d) is displayed, the page is transitioned to the server designation page shown in (c). This server designation page is in the state the server which was selected in the mail list is selected by the cursor. When it is judged that the escape switch is pushed when the server designation page shown in (c) is displayed, the page is transitioned to the top menu page shown in (b). This top menu page is in the state ‘mail list’ is selected by the cursor, since the page was restored from the mail list page. When it is judged that the escape switch is pushed when the top menu page is displayed, the page is transitioned to the menu page shown in (a). This menu page is in the state ‘mail’ is selected by the cursor. When it is judged in the mail page shown in (e) that the ‘application end’ is touched, the page is transitioned to the menu page shown in (a). This menu page is in the state ‘mail’ is selected by the cursor. When it is judged in the menu page that ‘mail’ is touched, the page is transitioned to the page displayed at the end of the previous operation.

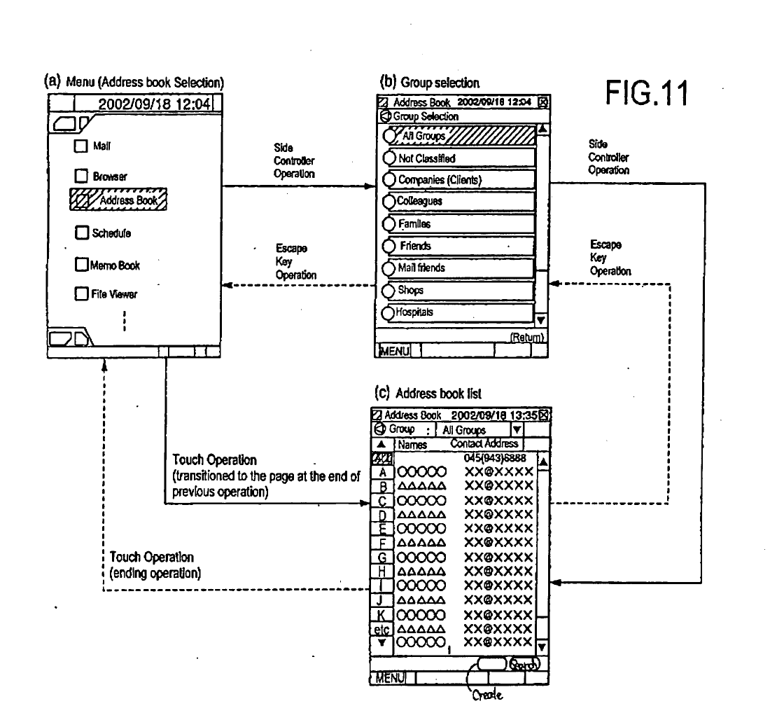

In FIG. 11, (a) shows the menu page, in which ‘address book’ is shaded. In this state, when it is judged that the side controller is pushed-in, the page is transitioned to the group selection page shown in (b). When the side controller is turned to select a desired group and then it is judged that the side controller is pushed-in, the page is transitioned to the address book list page shown in (c) and the address list of the selected group is displayed. When it is judged in the menu page that item ‘address book’ is touched, the page is transitioned to the page which was displayed at the end of the previous operation.

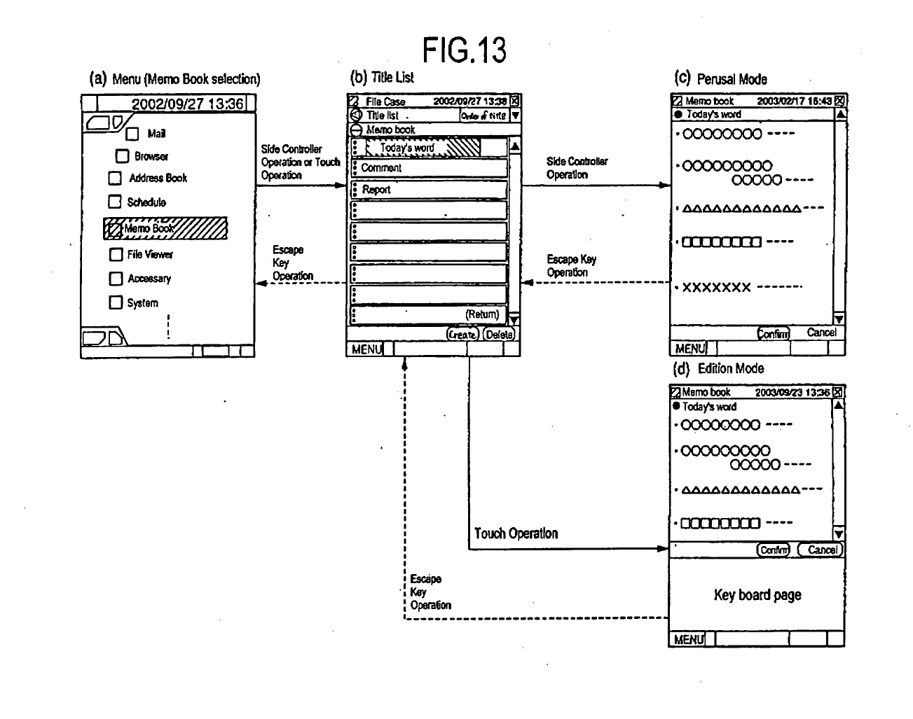

When it is judged that the escape switch is pushed when the address book list page shown in FIG. 13(c) is displayed, the page is transitioned to the group selection page shown in (b). This group selection page is in the state the item of the group which was selected in the address book list page is selected by the cursor. When it is judged that the escape switch is pushed when the group selection page shown in (b) is displayed, the page is transitioned to the menu page shown in (a). This menu page is in the state ‘address book’ is selected by the cursor. When it is judged that ‘application end’ is touched when the address book list shown in (c) is displayed, the page is transitioned to the menu page shown in (a). This menu page is in the state ‘address book’ is selected by the cursor.

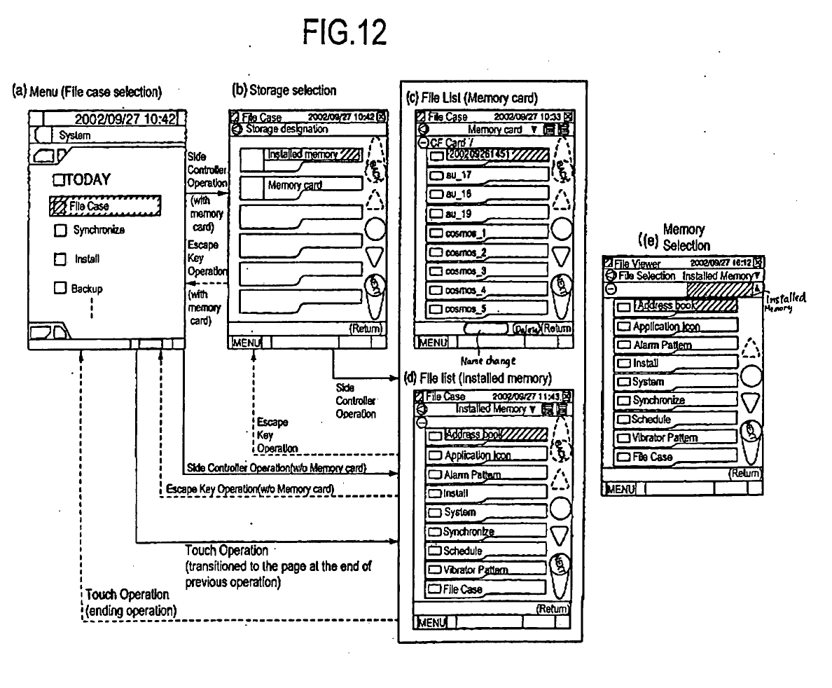

In FIG. 12, (a) shows the menu page, in which ‘file case’ is shaded. In this state, when it is judged that the side controller is pushed-in, whether a memory card is inserted in the equipment (personal digital assistant) or not is detected, and when the memory card is inserted, the page is transitioned to the storage selection page shown in (b). When the memory card is not inserted, the page is transitioned the file list (installed memory) page shown in (d). When it is judged that the side controller is pushed-in in the state the file desired to be displayed is selected by turning the side controller, the page is transitioned to the file list (memory card) page shown in (c) when ‘memory card’ is selected, and transitioned to the file list (installed memory) page shown in (d) when ‘installed memory’ is selected. When it is judged in the menu page that ‘file case’ is touched, the page is transitioned to the page displayed at the end of the previous operation. In the case the file list of the memory card is displayed when the memory card is inserted the last time and this time the memory card is not inserted, the page is transitioned to the file list page of the installed memory.

In the case the memory card is inserted in the equipment, when it is judged that the escape switch is pushed when the file list (memory card) page shown in (c) or the file list (installed memory) page shown in (d), the page is transitioned to the storage selection page shown in (b). This storage selection page is in the state the card which was being displayed is selected by the cursor. When it is judged that the escape switch is pushed when the storage selection page shown in (b) is displayed, the page is transitioned to the menu page shown in (a). This menu page is in the state ‘file case’ is selected by the cursor. When it is judged in the file list (memory cars) page shown in (c) or the file list (installed memory) shown in (d) that ‘application end’ is touched, the page is transitioned to the menu page shown in (a). This menu page is in the state ‘file case’ is selected by the cursor.

In FIG. 13, (a) shows the menu page, in which ‘memo book’ is shaded. In this state, when it is judged that the side controller is pushed-in or ‘memo book’ is touched, the page is transitioned to the title list shown in (b). When the title of the memo desired to be displayed is selected by turning the side controller and then the same is pushed-in when the title list is displayed, the contents of the memo is displayed in the perusal mode shown in (c). In the perusal mode, the picture can be scrolled. When it is judged in the title list page that the title of the memo desired to be displayed is touched, the contents of the memo is displayed in the edition mode shown in (d). In the edition mode, the cursor is displayed, a character input panel is displayed, and memo edition can be performed immediately.

When it is judged that the escape switch is pushed when the perusal mode shown in (c) is displayed, the page is transitioned to the title list page shown in (b). This title list page is in the state the title of the memo which was being displayed is selected by the cursor. When it is judged that the escape switch is pushed when the edition mode shown in (d) is displayed, the page is transitioned to the title list page shown in (b). This title list page is in the state the title of the memo which was being edited is selected by the cursor.

Next, the embodiment corresponding to claim 1 of the present invention will be explained. In FIG. 9, when it is judged in the menu page shown in (a) that ‘schedule’ is touched, the page is transitioned to the page displayed at the end of previous operation among the half-year page shown in (c), month page shown in (d), week page shown in (e), or to-do page shown in (f). When it is judged that side controller is pushed-in in the state ‘schedule’ is selected, the page is transitioned to the top menu page shown in (b).

In FIG. 10, when it is judged in the menu page shown in (a) that ‘mail’ is touched, the page is transitioned to the page displayed at the end of the previous operation (may be to the page of newly arrived mail list, mail writing, mail list, batch transmission and reception, draft, and server environment setting; in the embodiment, to the mail list page). When it is judged that the side controller is pushed-in when ‘mail’ is selected by the cursor, the page is transitioned to the top menu page shown in (b) of the mail application.

In FIG. 11, when it is judged in the menu page shown in (a) that ‘address book’ is touched, the page is transitioned to the page displayed at the end of the previous operation (in the embodiment, to the address list page). When it is judged that the side controller is pushed-in when ‘address book’ is selected by the cursor, the page is transitioned to the group selection menu page shown in (b) of the address book application.

In FIG. 12, when it is judged in the menu page shown in (a) that ‘file case’ is touched in the state the memory card is inserted in the equipment (personal digital assistant), the page is transitioned to the page displayed at the end of the previous operation, which is either of the file list (memory card) page shown in (c) or the file list (installed memory) page shown in (d) of the file case application. When it is judged that the side controller is pushed-in when ‘file case’ is selected by the cursor, the page is transitioned to the storage selection page shown in (b).

In FIG. 13, in the state the title list is displayed shown in (b), when it is judged that a certain title is touched, the page is transitioned to the edition mode shown in (d) of the memo book application, when it is judged that the side controller is pushed-in, the page is transitioned to the perusal mode page shown in (b) of the memo book application.

The embodiment corresponding to claim 9 of the present invention is restricted to the case the touch panel is provided in the case of embodiment of claim 1.

The embodiment corresponding to claim 10 of the present invention is restricted to the case the touch panel and input operation part are provided in the case of embodiment of claim 1.

Next, the embodiment corresponding to claim 2 will be explained. The operation pages on each of which a plurality of items are prescribed for selection are the menu pages shown in (a) and (b) of FIG. 9˜FIG. 13. In the case of FIG. 10, the server designation page shown in (c) of the drawing is also included. An item in those pages can be selected by the cursor by turning the control switch (side controller), and then when the same is pushed-in the page is transitioned to the page pertinent to the item selected, for example, from the page shown in (a) to the page shown in (b) in FIG. 9˜FIG. 13.

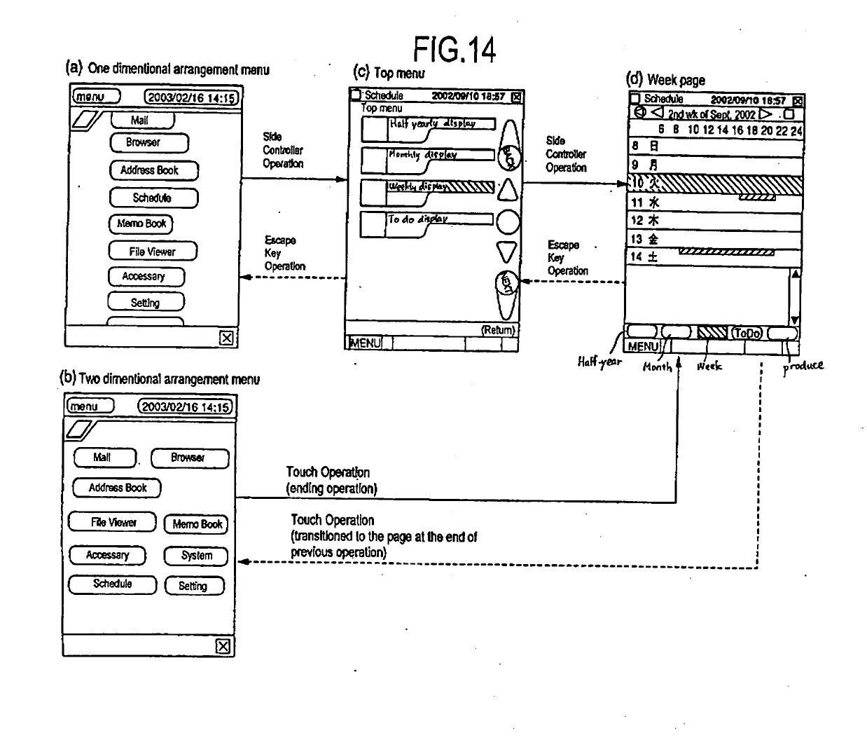

With the embodiment corresponding to claim 11 and claim 12 of the present invention, when the selection items are arranged in one-dimension (arrangement in one column) as shown in (a) of FIG. 14 before operation, the arrangement of the selection items changes to that of two-dimension (arrangement in a plurality of columns) as shown in (b) of FIG. 14 upon the operation to the touch panel, but the arrangement does not change and remains as is shown in (b) of FIG. 14 upon the operation of the control switch. On the other hand, when the selection items are arranged in two-dimension as shown in (b) of FIG. 14 before operation, the arrangement of the selection items remains as it is upon the operation to the touch panel, but the arrangement changes to that of one-dimension as shown in (a) of FIG. 14 upon the operation of the control switch. When the week page shown in (d) of FIG. 14 is displayed, the page is transitioned to the top menu page upon the operation of the escape switch, and the page is transitioned to the two-dimensional arrangement page shown in (b) upon the operation to the touch panel. In this way, when touch operation is difficult because some of the selection items are hidden and not displayed in the case of one-column arrangement, the items become displayed in two-dimensional arrangement in which all items are displayed upon the touch operation, and the selection of item becomes easy.

Next, the embodiment corresponding to claim 3 of the present invention will be explained. In the state ‘schedule’ is selected by the cursor as shown in (a) of FIG. 9, when it is judged that the control switch is turned upward, the operation page changes to the state ‘address book’ is selected by the cursor as shown in (a) of FIG. 11. In the state ‘schedule’ is selected by the cursor as shown in (a) of FIG. 9, when it is judged that the control switch is turned downward, the operation page changes to the state ‘memo book’ is selected by the cursor as shown in (a) of FIG. 13.

Next, the embodiment corresponding to claim 4 of the present invention will be explained. In the menu page, when ‘schedule’, ‘mail’, ‘address book’, or ‘file case’ is selected respectively as shown in (a) of FIG. 9, FIG. 10, FIG. 11, or FIG. 12 by the cursor by turning the control switch and then the same is pushed-in, the page is transitioned from the menu page shown respectively in (a) of FIG. 9, FIG. 10, FIG. 11, or FIG. 12 to the page shown respectively in (b) of FIG. 9, FIG. 10, FIG. 11, or FIG. 12, that is, respectively to the top menu page in which ‘weekly’ is selected, the top menu page in which ‘mail list is selected, the group selection page in which ‘all groups’ is selected, or the storage designation page in which ‘installed memory’ is selected.

Next, the embodiment corresponding to claim 5 of the present invention will be explained. In menu page, when ‘schedule’, ‘mail’, ‘address book’, or ‘file case’ is selected respectively as shown in (a) of FIG. 9, FIG. 10, FIG. 11, or FIG. 12 by the cursor by turning the control switch and then the same is pushed-in, the page is transitioned from the menu page shown respectively in (a) of FIG. 9, FIG. 10, FIG. 11, or FIG. 12 to the page shown respectively in (b) of FIG. 9, FIG. 10, FIG. 11, or FIG. 12, that is, respectively to the top menu page in which ‘weekly’ is selected, the top menu page in which ‘mail list is selected, the group selection page in which ‘all groups’ is selected, or the storage designation page in which ‘installed memory’ is selected.

Next, the embodiment corresponding to claim 13 of the present invention will be explained. In FIG. 9, when it is judged in the menu page shown in (a) that ‘schedule’ is touched, the page is transitioned to the page (the page with detailed selection items arranged) displayed at the end of previous operation among the half-year page shown in (c), month page shown in (d), week page shown in (e), or to-do page shown in (f). When it is judged that side controller is pushed-in in the state ‘schedule’ is selected, the page is transitioned to the top menu page (the page with simple selection items arranged) shown in (b).

In FIG. 10, when it is judged in the menu page shown in (a) that ‘mail’ is touched, the page is transitioned to the page (the page with detailed selection items arranged) displayed at the end of the previous operation (may be to the page of newly arrived mail list, mail writing, mail list, batch transmission and reception, draft, and server environment setting; in the embodiment, to the mail list page). When it is judged that the side controller is pushed-in when ‘mail’ is selected by the cursor, the page is transitioned to the top menu page (the page with simple selection items arranged) shown in (b) of the mail application.

In FIG. 11, when it is judged in the menu page shown in (a) that ‘address book’ is touched, the page is transitioned to the page (the page with detailed selection items arranged) displayed at the end of the previous operation (in the embodiment, to the address list page). When it is judged that the side controller is pushed-in when ‘address book’ is selected by the cursor, the page is transitioned to the group selection menu page (the page with simple selection items arranged) shown in (b) of the address book application.

In FIG. 12, when it is judged in the menu page shown in (a) that ‘file case’ is touched in the state the memory card is inserted in the equipment (personal digital assistant), the page is transitioned to the page (the page with detailed selection items arranged) displayed at the end of the previous operation, which is either of the file list (memory card) page shown in (c) or the file list (installed memory) page shown in (d) of the file case application. When it is judged that the side controller is pushed-in when ‘file case’ is selected by the cursor, the page is transitioned to the storage selection page (the page with simple selection items arranged) shown in (b).

Next, the embodiment corresponding to claim 14 of the present invention will be explained. In FIG. 9, when it is judged in the menu page shown in (a) that ‘schedule’ is touched, the page is transitioned to the page displayed at the end of previous operation among the half-year page shown in (c), month page shown in (d), week page shown in (e), or to-do page shown in (f). When it is judged that side controller is pushed-in in the state ‘schedule’ is selected, the page is transitioned to the top menu page shown in (b).

When it is judged that the control switch is pushed-in in the state ‘half-yearly’ is selected by the cursor in the top menu page shown in (b), the page is transitioned to the half-year page of lower layer shown in (c).

When it is judged that the control switch is pushed-in in the state ‘monthly’ is selected by the cursor, the page is transitioned to the month page of further lower layer shown in (d). When it is judged that the control switch is pushed-in in the state ‘weekly’ is selected by the cursor, the page is transitioned to the week page of still further lower layer shown in (e). When it is judged that the control switch is pushed-in in the state ‘to-do’ is selected by the cursor, the page is transitioned to the to-do page of yet further lower layer shown in (f).

In FIG. 10, when it is judged in the menu page shown in (a) that ‘mail’ is touched, the page is transitioned to the page displayed at the end of the previous operation (may be to the page of newly arrived mail list, mail writing, mail list, batch transmission and reception, draft, and server environment setting; in the embodiment, to the mail list page). When it is judged that the side controller is pushed-in when ‘mail’ is selected by the cursor, the page is transitioned to the top menu page shown in (b) of the mail application. For example, when it is judged that the control switch is pushed-in in the state ‘mail list’ is selected by the cursor in the top menu page shown in (b), the page is transitioned to the server designation page of lower layer shown in (c).

Further, when it is judged that the control switch is pushed-in in the state a certain server name is selected by the cursor in the server designation page shown in (c), the page is transitioned to the folder designation page of further lower layer shown in (d). When it is judged that the control switch is pushed-in in the state a certain folder is selected by the cursor in the folder designation page shown in (d), the page is transitioned to the mail list page of still further lower layer shown in (e).

In FIG. 11, when it is judged in the menu page shown in (a) that ‘address book’ is touched, the page is transitioned to the page displayed at the end of the previous operation (in the embodiment, to the address list page). When it is judged that the side controller is pushed-in when ‘address book’ is selected by the cursor, the page is transitioned to the group selection menu page shown in (b) of the address book application. For example, when it is judged that the control switch is pushed-in in the state ‘all group’ is selected by the cursor in the group selection page shown I (b), the page is transitioned to the address book list page of lower layer shown in (c).

In FIG. 12, when it is judged in the menu page shown in (a) that ‘file case’ is touched in the state the memory card is inserted in the equipment (personal digital assistant), the page is transitioned to the page displayed at the end of the previous operation, which is either of the file list (memory card) page shown in (c) or the file list (installed memory) page shown in (d) of the file case application. When it is judged that the side controller is pushed-in when ‘file case’ is selected by the cursor, the page is transitioned to the storage selection page shown in (b).

When it is judged that the control switch is pushed-in in the state ‘installed memory’ is selected in the storage selection page shown in (b), the page is transitioned to the file list (installed memory) page of further lower layer shown in (d). When it is judged that the control switch is pushed-in in the state ‘memory card’ is selected in the storage selection page shown in (b), the page is transitioned to the file list (memory card) page of still further lower layer shown in (c).

Next, the embodiment corresponding to claim 15 of the present invention will be explained. When an item is selected among the menu pages and touched on the touch panel, the application page pertinent to the item can be selected, for example, execution page of the schedule book, and the page setting such as the coloration and range of time to be displayed (for example, for one-week or two-week, etc.), etc. of the schedule book can be selected. On the other hand, when the schedule book is selected by using the control switch, the page setting can not be selected.

As has been described in the foregoing, when it is judged that the touch operation on the display part is done, the first page transition is carried out in which the operation page displayed on the display part is transitioned in accordance with the touch operation, and when it is judged that the control switch is operated, the second page transition is carried out in which the operation page displayed on the display part is transitioned in accordance with the operation of the control switch, so that it is possible to constitute such that, with the control switch operation the restricted page transition suitable to be done in mobile environment can be done, on the other hand, with the touch operation all of the page transition can be done. As a result, page transition is divided in two ways, i.e. by the control switch operation and by touch operation, and the operationality is extremely improved.

On the operation page, a plurality of items are determined as items for selection, and when it is judged that the control switch is turned, the second page transition is done to select an item among the selection items in compliance with the turning operation of the control switch, and then the page is transitioned to the selected page by pushing the control switch. Therefore, the effect that the transition of operation page can be performed in an extremely easy manner can be obtained.

When it is judged that the control switch is turned, the cursor is shifted on the operation page in the direction of the turning of the control switch, more specifically in the direction of the movement of the thumb of the operator. Therefore, the direction of the cursor shift and that of the thumb movement coincides resulting in good operationality.

When said judging means judges that the turning operation of said control switch is done, said display control means performs the selection of an item from the predetermined selection items among the items displayed in said operation page as selection items and then, when it is judged that the pushing operation of said control switch is done, the second page transition control is performed whereby the page is transitioned to the operation page pertinent to said selected item. Therefore, it is possible to allow the selection of fundamental items from the selection items and its execution by the operation of the control switch, and by combining the control switch operation with the touch operation the operationality in mobile environment, etc. can be improved.

The display control means allows the cursor to move on the operation page in accordance with the turning operation of said control switch and performs the second page transition control to changeover to the page determined by the position of the cursor by the pushing operation of said control switch, and the page to be transitioned to is determined by the turning and pushing operation of the control switch. Therefore, the operationality when performing page transition is improved.

The control switch is supported on a shaft extending in a certain direction so that the same is rotatable in a certain range of angle from a reference position of rotation and can be pushed-in in the direction perpendicular to the direction of rotation at said reference position of rotation. As the range of turning of the control switch is defined and the control switch always comes back to the reference position, the operationality when shifting the cursor is improved.

The display part is positioned on the front face of the encasement of the personal digital assistant, and the control switch is located on the side of the encasement of the personal digital assistant such that said shaft for supporting the control switch extends in the direction toward the rear face of the encasement of the personal digital assistant from the front face thereof. Therefore, a large area of display part can be secured with the small size of digital personal assistant and moreover the digital personal assistant can be held by one hand and the control switch can be operated by said hand.

An escape switch is provided on the side of the encasement of the personal digital assistant, and when said escape switch is pushed said display control means carries out page return from the operation page after transition to the page before transition. Therefore, the returning to the page before transition can be easily done only by pushing the escape switch without operating the control switch.

What is claimed is:

1. A personal digital assistant having a display responsive to a touch operation comprising:
a control switch which can be turned and pushed-in;
an operation signal in response to the turning or pushing operation of said control switch;
a judging means which judges whether said touch operation to said display is done or said control switch is operated;
a display control means which performs a first page transition control for transitioning an operation page displayed on said display in accordance with said touch operation when said judging means judges that said touch operation is done to said display, or performs a second page transition control for transitioning said operation page displayed on said display part in accordance with said operation signal.

2. The personal digital assistant according to claim 1, wherein a plurality of items are displayed on said operation page as selection items, and said display control means performs the selection of an item from said selection items in accordance with the operation signal when said control switch is turned and said second page transition control whereby the page is transitioned to said operation page pertinent to the item selected in accordance with the operation signal when said control switch is pushed.

3. The personal digital assistant according to claim 1, wherein said display control means allows a cursor to move on said operation page in the direction corresponding to the turning direction of said control switch.

4. The personal digital assistant according to claim 2, wherein said display control means allows a cursor to move on said operation page in the direction corresponding to the turning direction of said control switch.

5. The personal digital assistant according to claim 2, wherein said display control means performs the selection of an item from the selection items among the items displayed in said operation page as selection items when said control switch is turned and said second page transition control is performed when said control switch is pushed whereby said page is transitioned to said operation page pertinent to said selected item.

6. The personal digital assistant according to claim 1, wherein said display control means allows said cursor to move on said operation page in accordance with said turning operation of said control switch and said second page transition control changes to said page determined by the position of said cursor by pushing said control switch.

7. The personal digital assistant according to claim 1, wherein said control switch is supported on a shaft extending in a direction so that said control switch is rotatable in a certain range of angle from a reference position of rotation and can be pushed in to a direction perpendicular to the direction of rotation at said reference position of rotation.

8. The personal digital assistant according to claim 7, wherein said display part is positioned on a front face of an encasement of said personal digital assistant, and said control switch is located on a side of said encasement of said personal digital assistant such that a shaft for supporting said control switch extends in a direction toward a rear face of said encasement of said personal digital assistant.

9. The personal digital assistant according to claim 1, wherein an escape switch is provided on said side of the encasement of the personal digital assistant, and when said escape switch is pushed said display control means carries out page return from said operation page after transition to said page before transition.

10. A personal digital assistant comprising:
a touch panel;
an operation page being displayed on the touch panel;
a page on the touch panel being transitioned by a touch operation to said operation page;
a control switch which can be turned and pushed in to transmit an operation signal
a judging means for judging which of said touch operation to said display part or said control switch operation is done and;
a display control means which changes to said first operation page when said judging means judges that said display part is touched, and which changes to the second operation page when receiving said control switch operation signal.

11. A personal digital assistant comprising:
a touch panel;
an operation page which is displayed on said touch panel when said touch panel is touched;
an input operation part, in which a variety of operation pages can be selectively displayed on the touch panel;
a control switch which is rotatable in a certain range of angle and can be pushed in;
a judging means for judging which of said touch operation to said display part or the control switch operation is done; and
a display control means which changes to said first operation page when said judging means judges that said display part is touched and which changes to said second operation page when receiving said control switch operation signal.

12. A personal digital assistant comprising:
a touch panel;
an input operation part, in which a variety of operation pages each having a plurality of selection items can be selectively displayed on said touch panel;
an operation page on the touch panel displayed on the touch panel by touching to the position of an arbitrary item among the selection items displayed on the touch panel or by selecting an arbitrary item from the selection items conducted by the operation in said input operation part;
a control switch which is rotatable in a certain range of angle and can be pushed in;
a selection item determining means for selecting an arbitrary item from said selection items displayed on said touch panel by turning and pushing in said control switch;
a judging means for judging which of said touch operation to said display part or said control switch operation is done, and;
a display control means which changes to said first operation page having the arrangement of selection items suited for the touch operation when said judging means judges that the touch operation is done to the touch panel and changes to said second operation page having the arrangement of selection items suited for the control switch operation when said judging means judges that the operation of said control switch is done.

13. The personal digital assistant according to claim 12, wherein said display control means allows said selection items to be arranged in a plurality of columns in said first operation page and to be arranged in one column in said second operation page.

14. A personal digital assistant comprising:
a touch panel;
an input operation part, in which a variety of operation pages each having a plurality of selection items can be selectively displayed on said touch panel;
an operation page on the touch panel selected by touching an arbitrary item among a selection items in said page displayed on said touch panel or selecting an arbitrary item from the selection items conducted by the operation of said input operation part;
a control switch which is rotatable in a certain range of angle and can be pushed in;
a selection item determining means for selecting an arbitrary item from the selection items displayed on the touch panel by turning and pushing in the control switch;
a judging means for judging which of said touch operation to said display or said control switch operation is done, and;
a display control means which changes to said first operation page in which are arranged detailed selection items suited for the touch operation when said judging means judges that the touch operation is done to the touch panel and which changes to said second operation when said judging means judges that the operation of said control switch is done.

15. A personal digital assistant comprising:
a touch panel;
an input operation part, in which a variety of operation pages each having a plurality of selection items can be selectively displayed on said touch panel;
an operation page on said touch panel selected by touching said arbitrary item among an selection items displayed on said touch panel or by selecting said arbitrary item from said selection items conducted by the operation in said input operation part;
a control switch which is rotatable in a certain range of angle and can be pushed in;
a selection item determining means for selecting an arbitrary item from said selection items displayed on the touch panel by said control switch;
a judging means for judging which of the touch operation to said display part or the control switch operation is done, and;
a display control means which changes immediately to said first operation page of a layer under the operation page under display when said judging means judges that said touch operation is done to the touch panel and which changes first to said second operation page of said layer under the operation page under display and then to said first operation page when said judging means judges that the operation of said control switch is done.

16. A personal digital assistant comprising:
a touch panel
an input operation part, in which a variety of operation pages each having a plurality of selection items can be selectively displayed on said touch panel;
an operation page on the touch panel selected by touching the touch panel to the position of an arbitrary item among the selection items displayed on the touch panel or selecting an arbitrary item from the selection items conducted by the operation in said input operation part;
a control switch which is rotatable in a certain range of angle and can be pushed in;
a selection item determining means for selecting an arbitrary item from the selection items displayed on the touch panel by the control switch turning operation and determining said selected item by the control switch pushing operation;
a judging means for judging which of said the touch operation to said display part or said control switch operation is done; and
an execution control means which carries out, when said judging means judges that the touch operation is done to the touch panel, the execution of various functions and various setting in accordance with an arbitrary selection item on the touch panel and which carries out, when said judging means judges that the operation of said control switch is done, only the execution of various functions in accordance with an arbitrary selection item selected by the operation of the control switch.

17. A page transition control program for operation in the personal digital assistant, comprises:
a judging step for judging whether a control switch is rotated in a certain range of angle and is pushed in or an operation page displayed on a display where a variety of operation pages is selected by touched;
a first page transition control step for performing a first page transition control by which said operation page displayed on said display is transitioned in accordance with said touch operation when it is judged that said display is touched; and
a second page transition control step for performing a second page transition control by which said operation page displayed on said display is transitioned in accordance with said control switch operation when it is judged that said control switch is operated.
